(19) United States
(12) Patent Application Publication
(10) Pub. No.: US 2007/0223457 A1
(43) Pub. Date: Sep. 27, 2007

(54) Packet switch scheduling apparatus with output schedulers and input schedulers performing scheduling processes separately

(75) Inventors: Toshiaki Arikawa, Tokyo (JP); Kenshin Yamada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/723,924

(22) Filed: Mar. 22, 2007

(30) Foreign Application Priority Data
Mar. 23, 2006 (JP) 2006-080835

(51) Int. Cl. H04L 12/66

(52) U.S. Cl. 370/352

(57) ABSTRACT

A packet switch scheduling apparatus in a packet communication apparatus is disclosed. Output schedulers select respective input lines, which are to be connected to a crossbar switch, for respective output lines. If previously selected input lines overlap each other, input schedulers select respective output lines for respective input lines, and output canceling information to those output schedulers which correspond to overlapping output lines that have not been selected. When the output schedulers are supplied with the canceling information, the output schedulers increments the value of request counters for the input lines corresponding to the input schedulers which have output the canceling information.

### BACKGROUND OF THE INVENTION

1. Field of the Invention

The present invention relates to a packet communication apparatus, and more particularly to a variable-length packet communication apparatus for switching variable-length packets.

The present invention can find application in the quick judgment of connection settings to connect an input line and an output line one-to-one in an input-buffer packet switch which is connected to fast input and output lines and which accommodates a number of lines.

2. Description of the Related Art

Since use of the Internet has been growing and access lines thereof have become faster in recent years, network data traffic has been increasing rapidly. To cope with the increasing network data traffic, there are demands for faster communication paths and for faster and greater-capacity communication devices such as routers.

Buffers for use in packet switches are generally classified into output buffers, shared buffers, crosspoint buffers, and input buffers.

Heretofore, output-buffered packet switches and shared-buffered packet switches have mainly been used in view of their high throughputs. However, faster line speeds and more lines available in recent years have drawn renewed attention to input-buffered packet switches that have a relatively low memory access rate. For example, an output-buffered packet switch has a memory access rate that is N+1 times the line rate (where N represents the number of lines), and a shared-buffered packet switch has a memory access rate that is 2N times the line speed. An input-buffered packet switch has a memory access rate that is twice the line speed and hence is lower than the memory access rates of the output-buffered packet switch and the shared-buffered packet switch.

It is known in the art that the throughput of input-buffered packet switches is reduced to 58.6% generally due to HOL (Head of Line) blocking. It is also known in the art that a throughput of 100% can be achieved by logically dividing input buffer FIFO (First In First Out) packets for respective output lines to set up VOQ (Virtual Output Queue). Crosspoint-buffered packet switches are equivalent in characteristics to input-buffered packet switches as to memory access rates and throughputs. However, since a crosspoint-buffered packet switch needs a buffer for each crosspoint, if each of the number of input lines and the number of output lines is N, then the packet switch requires (N×N) buffers and hence has a large hardware scale.

FIG. 1 of the accompanying drawings shows an overall arrangement of a general input-buffered packet switch. As shown in FIG. 1, the input-buffered packet switch comprises N input buffers 1-1 through 1-N, scheduler 3, crossbar switch 2, and N output buffers 4-1 through 4-N. Scheduler 3 uses, as its scheduling algorithm, iSLIP proposed in “The iSLIP Scheduling Algorithm for Input-Queued Switches”, Nick McKeown, IEEE Transactions on Networking, Vol. 7, No. 2, April 1999, pp. 188-201.

Input buffers 1-1 through 1-N are connected respectively to N input lines #1 through #N. Input buffers 1-1 through 1-N divide variable-length frames input from the corresponding input lines into fixed-length packets and store the fixed-length packets therein. Input buffers 1-1 through 1-N comprise respective input processors 5-1 through 5-N, respective packet buffers 6-1 through 6-N, and respective VOQ managers 7-1 through 7-N. Input processors 5-1 through 5-N divide variable-length frames input from the corresponding input lines into one fixed-length packet or a plurality of fixed-length packets. Packet buffers 6-1 through 6-N have respective N queues. These queues are VOQs (Virtual Output Queues) #1 through #N corresponding respectively to output lines #1 through #N, and store packets whose destinations are designated as the output lines. VOQ managers 7-1 through 7-N monitor the numbers of fixed-length packets stored in the respective VOQs, output a scheduling request REQ (REQuest) to scheduler 3, read one fixed-length packet from the VOQ corresponding to the output line that is included in a scheduling result ACC (ACCept) from scheduler 3, and output the read fixed-length packet to crossbar switch 2.

Based on scheduling requests sent from respective input buffers 1-1 through 1-N, scheduler 3 performs competitive control on time slots of crossbar switch 2 to be used for transferring packets from input buffers 1-1 through 1-N to output buffers 4-1 through 4-N. Specifically, scheduler 3 performs a process of determining output lines permitted for respective N input buffers 1-1 through 1-N so that input lines and output lines will not be overlappingly connected in each time slot. The scheduling result is sent to input buffers 1-1 through 1-N and crossbar switch 2.

Based on the scheduling result, crossbar switch 2 changes connections of input ports and output ports in each time slot, and transfers fixed-length packets read from respective input buffers 1-1 through 1-N to output buffers designated by the scheduling result.

Output buffers 4-1 through 4-N are connected respectively to N output lines #1 through #N. Output buffers 4-1 through 4-N comprise respective N queues 8-1 through 8-N, respective output processors 9-1 through 9-N, and respective VIQ managers 10-1 through 10-N. N queues 8-1 through 8-N are VIQs (Virtual Input Queues) #1 through #N corresponding-respectively to input lines #1 through #N, and store packets whose sources are designated as the input lines. Packets input from crossbar switch 2 to output buffers 4-1 through 4-N are multiplexed fixed-length packets, which have been converted by input buffers 1-1 through 1-N, from the input lines. Output processors 9-1 through 9-N read one frame of fixed-length packets that constitute one variable-length packet from VIQs 8-1 through 8-N in order of arrival, generates original variable-length frames from the read fixed-length packets, and output the generated original variable-length frames to respective output lines #1 through #N.

FIG. 12 of the accompanying drawings shows in detailed block form a conventional arrangement of scheduler 3. As shown in FIG. 12, scheduler 3 comprises N output schedulers 31-1 through 31-N and N input schedulers 32-1 through 32-N.

Output scheduler 31-1 comprises request counters 33-1-1 through 33-1-N for counting requests from all input lines #1 through #N to output line #1 for the respective input lines, grant pointer g1 (34-1) for indicating a leading end of the round-robin rules, and controller 37-1 for controlling request counters 33-1-1 through 33-1-N and grant pointer g1 (34-1). Output schedulers 31-2 through 31-N comprise request counters 33-2-1 through 33-N-N for counting requests from all input lines #1 through #N to corresponding output lines for the respective input lines, grant pointers g2 through gN (34-2 through 34-N) for indicating leading ends of the round-robin rules, and controllers 37-2 through 37-N for controlling request counters 33-2-1 through 33-N-N and grant pointers g2 through gN (34-2 through 34-N).

Input scheduler 32-1 comprises grant registers 35-1-1 through 35-1-N for extracting grants for input line #1 from selected results of all-output schedulers 31-1 through 31-N and for holding the extracted grants for the respective output lines, accept pointer a1 (36-1) for indicating a leading end of the round-robin rules, and controller 38-1 for controlling grant registers 35-1-1 through 35-1-N and accept pointer a1 (36-1). Input schedulers 32-2 through 32-N comprise grant registers 35-2-1 through 35-N-N for receiving selected results of all output schedulers 31-2 through 31-N, accept pointers a2 through aN (36-2 through 36-N) for indicating leading ends of the round-robin rules, and controllers 38-2 through 38-N for controlling grant registers 35-2-1 through 35-N-N and accept pointers a2 through aN (36-2 through 36-N).

Controller 37-1 of output scheduler 31-1 extracts requests whose destinations are designated as output line #1 from the scheduling requests input from VOQ managers 7-1 through 7-N for all input lines #1 through #N, and adds the number of requests on respective input lines by request counters 33-1-1 through 33-1-N. Controller 37-1 extracts cancels whose destinations are designated as output line #1 from canceling information input from input schedulers 32-1 through 32-N, and adds request counters 33-1-1 through 33-1-N for the respective input lines. Controller 37-1 selects one of the input lines for which the number of requests counted by counters 33-1-1 through 33-1-N is I or more, according to the round-robin rules with top priority given to grant pointer g1 (34-1), and outputs the selected input line as granted to input schedulers 32-1 through 32-N. Depending on the scheduling results input from input schedulers 32-1 through 32-N, controller 37-1 updates request counters 33-1-1 through 33-1-N and grant pointer g1 (34-1). Controller 37-1 decrements by 1 the request counter of the selected input line, and updates grant pointer g1 (34-1) to a value indicative of an input line next to the selected input line. For example, if input line #1 is selected, then controller 37-1 updates grant pointer g1 (34-1) to a value indicative of input line #2, and if input line #N is selected, then controller 37-1 updates grant pointer g1 (34-1) to a value indicative of input line #1.

Controller 37-2 of output scheduler 31-2 extracts requests whose destinations are designated as output line #2 from the scheduling requests input from VOQ managers 7-1 through 7-N for all input lines #1 through #N, and adds the number of requests on respective input lines by request counters 33-2-1 through 33-2-N. Controller 37-2 extracts cancels whose destinations are designated as output line #2 from canceling information input from input schedulers 32-1 through 32-N, and adds the number of requests on respective input lines by request counters 33-2-1 through 33-2-N. Controller 37-2 selects one of the input lines for which the number of requests counted by counters 33-2-1 through 33-2-N is 1 or more, according to the round-robin rules with top priority given to grant pointer g2 (34-2), and outputs the selected input line as granted to input schedulers 32-1 through 32-N. Depending on the scheduling results input from input schedulers 32-1 through 32-N, controller 37-2 updates request counters 33-2-1 through 33-2-N and grant pointer g2 (34-2). Controller 37-2 decrements by 1 the request counter of the selected input line, and updates grant pointer g2 (34-2) to a value indicative of an input line next to the selected input line. For example, if input line #1 is selected, then controller 37-2 updates grant pointer g2 (34-2) to a value indicative of input line #2, and if input line #N is selected, then controller 37-2 updates grant pointer g2 (34-2) to a value indicative of input line #1.

Controllers 37-3 through 37-N of output schedulers 31-3 through 31-N also perform the same controlling process as controller 37-1 of output scheduler 31-1 and controller 37-2 of output scheduler 31-2.

Controller 38-1 of input scheduler 32-1 extracts grants whose sources are designated as input line #1 from the grants input from all output schedulers 31-1 through 31-N, and stores the extracted grants in grant registers 35-1-1 through 35-1-N for the respective output lines. If there are no corresponding grants, then controller 38-1 clears the grant registers (no grants). Controller 38-1 selects one of the output lines for which grants are included in the grant registers, according to the round-robin rules with top priority given to accept pointer a1 (36-1), and outputs the number of the selected output line as a scheduling result to VOQ manager 7-1 of input buffer 1-1. Controller 38-1 updates accept pointer a1 (36-1) to a value indicative of an output line next to the selected output line. For example, if output line #1 is selected, then controller 38-1 updates accept pointer a1 (36-1) to a value indicative of output line #2, and if output line #N is selected, then controller 38-1 updates accept pointer a1 (36-1) to a value indicative of output line #1. If none of grant registers 35-1-1 through 35-1-N store grant information, then the scheduling result is output as unconnected, and accept pointer a1 (36-1) holds the preceding value.

Controller 38-2 of input scheduler 32-2 extracts grants whose sources are designated as input line #2 from the grants input from all output schedulers 31-1 through 31-N, and stores the extracted grants in grant registers 35-2-1 through 35-2-N for the respective output lines. If there are no corresponding grants, then controller 38-1 clears the grant registers (no grants). Controller 38-2 selects one of the output lines for which grants are included in the grant registers, according to the round-robin rules with top priority given to accept pointer a2 (36-2), and outputs the number of the selected output line as a scheduling result to VOQ manager 7-2 of input buffer 1-2. Controller 38-2 updates accept pointer a2 (36-2) to a value indicative of an output line next to the selected output line. If none of grant registers 35-2-1 through 35-2-N store grant information, then the scheduling result is output as unconnected, and accept pointer a2 (36-2) holds the preceding value.

Controllers 38-3 through 38-N of input schedulers 32-3 through 32-N also perform the same controlling process as controller 38-1 of input scheduler 32-1 and controller 38-2 of input scheduler 32-2.

Output schedulers 31-1 through 31-N and input schedulers 32-1 through 32-N operate in cooperation with each other to perform their processing in the same time slots.

FIGS. 13(a) and 13(b) of the accompanying drawings show a sequence of the processing operation of the schedulers shown in FIG. 12. After the results of an input scheduling process (step 3) are reflected in request counters according to the request counting process (step 1) and are also reflected in grant pointers according to an output scheduling process (step 2), the next process needs to be started. Therefore, the three processes are carried out serially as shown in FIG. 13(a). With a conventional input-buffered packet switch based on iSLIP, as shown in FIG. 13(b), after the three processes are carried out, an output scheduling process and an input scheduling process may further be carried out at a plurality of times between input lines and output lines that are not selected.

FIG. 14 of the accompanying drawings shows flowcharts of the request counting process (step 1), the output scheduling process (step 2), and the input scheduling process (step 3). In FIG. 14, “zmodN” represents the remainder produced when z is divided by N.

Operation of the scheduler shown in FIG. 12 where the number N of input/output lines is 4 will be described below with reference to FIGS. 12 and 14 through 17 of the accompanying drawings.

In step 1, output schedulers 31-1 through 31-4 count scheduling requests from input buffers 1-1 through 14 to output buffers 4-1 through 44 (FIGS. 15(a) through 15(c)). FIG. 15(a) shows the values of request counters 33-1-1 through 334-4 before step 1 is executed. FIG. 15(b) shows new scheduling requests REQ#1 through REQ#4 input from input buffers 1-1 through 1-4. FIG. 15(c) shows the values of request counters 33-1-1 through 33-4-4 after step 1 is executed. With respect to the combination of input line #1 and output line #1, the value “1” of the request counter (at the 1st row and the 1st column in FIG. 15(a)) and the value “1” of the request (at the 1st row and the 1st column in FIG. 15(b)) are added to each other, thereby updating the value of the request counter (at the 1st row and the 1st column in FIG. 15(c)) to “2”. With respect to the combination of input line #1 and output line #2, the value “0” of the request counter (at the 1st row and the 2nd column in FIG. 15(a)) and the value “0” of the request (at the 1st row and the 2nd column in FIG. 15(b)) are added to each other, thereby updating the value of the request counter (at the 1st row and the 2nd column in FIG. 15(c)) to “0”. Similarly, with respect to all combinations of the input lines and the output lines, the values of the request counters are updated.

In step 2, output schedulers 31-1 through 31-4 elect a request for each output line from the requests whose destinations are designated as output lines #1 through #4, according to the round-robin rules (FIGS. 16(a) through 16(c)). FIG. 16(a) shows requests from the input lines to the output lines and to grant pointers before step 2 is carried out, and FIG. 16(b) shows selected requests to the output lines and grant pointers after step 2 is carried out. FIG. 16(c) shows grants output from output schedulers 31-1 through 31-4 after step 2 is carried out. Controller 37-1 of output scheduler 31-1 searches for input lines for which the number of requests counted by the request counters is 1 or more, from input line #1 indicated by grant pointer g1 (34-1).

Since the request counter from input line #1 has a count of 2, controller 37-1 selects input line #1 as a candidate that can be connected to output line #1.

Controller 37-1 makes grants output to input scheduler 32-1 valid, i.e., sets them to “1” (at the 1st row and the 1st column in FIG. 16(c)), and makes grants output to input schedulers 32-2, 32-3, 32-4 invalid, i.e., sets them to “0” (at the 2nd row and the 1st column, the 3rd row and the 1st column, and the 4th row and the 1st column in FIG. 16(c)). Controller 37-2 of output scheduler 31-2 searches for input lines for which the number of requests counted by the request counters is 1 or more, from input line #2 indicated by grant pointer g2 (34-2). Since the request counter from input line #2 has a count of 2, controller 37-2 selects input line #2 as a candidate that can be connected to output line #2. Controller 37-2 makes grants output to input scheduler 32-2 valid, i.e., sets them to “1” (at the 2nd row and the 2nd column in FIG. 16(c)), and makes grants output to input schedulers 32-1, 32-3, 32-4 invalid, i.e., sets them to “0” (at the 1st row and the 2nd column, the 3rd row and the 2nd column, and the 4th row and the 2nd column in FIG. 16(c)). Controller 37-3 of output scheduler 31-3 searches for input lines for which the number of requests counted by the request counters is 1 or more, from input line #3 indicated by grant pointer g3 (34-3). Since the request counter from input line #3 has a count of 2, controller 37-3 selects input line #3 as a candidate that can be connected to output line #3. Controller 37-3 makes grants output to input scheduler 32-3 valid, i.e., sets them to “1” (at the 3rd row and the 3rd column in FIG. 16(c)), and makes grants output to input schedulers 32-1, 32-2, 32-4 invalid, i.e., sets them to “0” (at the 1st row and the 3rd column, the 2nd row and the 3rd column, and the 4th row and the 3rd column in FIG. 16(c)). Controller 37-4 searches for input lines for which the number of requests counted by the request counters is 1 or more, from input line #4 indicated by grant pointer g4 (34-4). Since the request counter from input line #4 has a count of 0, input line #4 cannot be selected as a candidate that can be connected to output line #4. The count of the request counter from input line #1, as it is referred to, according to the round-robin rules is 1. Controller 37-4 thus selects input line #1 as a candidate that can be connected to output line #4. Controller 37-4 makes grants output to input scheduler 32-1 valid, i.e., sets them to “1” (at the 1st row and the 4th column in FIG. 16(c)), and makes grants output to input schedulers 32-2, 32-3, 32-4 invalid, i.e., sets them to “0” (at the 2nd row and the 4th column, the 3rd row and the 4th column, and the 4th row and the 4th column in FIG. 16(c)).

In step 3, input schedulers 32-1 through 32-4 selects a grant for each input line from valid grants input from output schedulers 31-1 through 31-4 according to the round-robin rules (FIGS. 17(a) through 17(d)). FIG. 17(a) shows valid grants from the input lines to the output lines and accept pointers before step 3 is carried out, and FIG. 17(b) shows selected grants, grant pointers, and accept pointers after step 3 is carried out. FIG. 17(c) shows the value of the request counters after step 3 is carried out, and FIG. 17(d) shows scheduling results after step 3 is carried out. Controller 38-1 of Input scheduler 32-1 receives grants input from respective output schedulers 31-1 through 31-4 by grant registers 35-1-1 through 35-1-4. Controller 38-1 refers to grant register 35-1-2 for output line #2 indicated by accept pointer a1 (36-1), and it is invalid, i.e., it is set to “0”. Controller 38-1 refers to grant register 35-1-3 for next output line #3 according to the round-robin rules, and it is invalid, i.e., it is set to “0”. Controller 38-1 refers to grant register 35-1-4 for next output line #4, and it is valid, i.e., it is set to “1”. Therefore, controller 38-1 selects output line #4 as a line to which packets can be output. Controller 38-1 updates the value of accept pointer a1 to a value indicative of output line #1 according to the round-robin rules. Controller 38-1 makes a scheduling result ACC#1 output to input buffer 1-1 valid, i.e., sets it to “1”, only for output line #4 (at the 1st row and 4th column in FIG. 17(d)), and makes it invalid, i.e. sets it to “0”, for output lines #1, #2, #3 (at the 1st row and the 1st column, the 1st row and the 2nd column, and the 1st row and the 3rd column in FIG. 17(d)). Controller 38-2 of input scheduler 32-2 receives grants input from respective output schedulers 31-1 through 31-4 by grant registers 35-2-1 through 35-24. Controller 38-2 refers to grant register 35-2-1 for output line #1 indicated by accept pointer a2 (36-2), and it is invalid, i.e., it is set to “0”. Controller 38-2 refers to grant register 35-2-2 for next output line #2 according to the round-robin rules, and it is valid, i.e., it is set to “1”. Therefore, controller 38-2 selects output line #2 as a line to which packets can be output. Controller 38-2 updates the value of accept pointer a2 to a value indicative of output line #2 according to the round-robin rules. Controller 38-2 makes a scheduling result ACC#2 output to input buffer 1-2 valid, i.e., sets it to “1”, only for output line #2 (at the 2nd row and 2nd column in FIG. 17(d)), and makes it invalid, i.e. sets it to “0”, for output lines #1, #3, #4 (at the 2nd row and the 1st column, the 2nd row and the 3rd column, and the 2nd row and the 4th column in FIG. 17(d)). Controller 38-3 of Input scheduler 32-3 receives grants input from respective output schedulers 31-1 through 31-4 by grant registers 35-3-1 through 35-3-4. Controller 38-3 of Input scheduler 32-3 refers to grant register 35-3-1 for output line #1 indicated by accept pointer a3 (36-3), and it is invalid, i.e., it is set to “0”. Controller 38-3 refers to grant register 35-3-2 for next output line #2 according to the round-robin rules, and it is invalid, i.e., it is set to “0”. Controller 38-3 refers to grant register 35-3-3 for next output line #3, and it is valid, i.e., it is set to “1”. Therefore, controller 38-3 selects output line #3 as a line capable of outputting packets. Controller 38-3 updates the value of accept pointer a3 to a value indicative of output line #4 according to the round-robin rules. Controller 38-3 makes the scheduling result ACC#3 output to input buffer 1-3 valid, i.e., sets it to “1”, only for output line #3 (at the 3rd row and 3rd column in FIG. 17(d)), and makes it invalid, i.e., sets it to “0”, for output lines #1, #2, #4 (at the 3rd row and the 1st column, the 3rd row and the 2nd column, and the 3rd row and the 4th column in FIG. 17(d)). Controller 38-4 of input scheduler 32-4 receives grants input from respective output schedulers 31-1 through 31-4 by grant registers 35-4-1 through 35-4-4. Input scheduler 32-4 refers to grant register 35-4-3 for output line #3 indicated by accept pointer a4 (36-4), and it is invalid, i.e., it is set to “0”. Controller 38-4 refers to grant registers 35-4-4, 35-4-1, 35-4-2 for output lines #4, #1, #2 according to the round-robin rules, and all of them are valid, i.e., all of them are set to “1”. Therefore, controller 38-4 judges that there is no line to which packets can be output, and controls accept pointer a4 (36-4) to hold the preceding value. Input scheduler 32-4 makes the scheduling result ACC#4 output to input buffer 1-4 invalid, i.e., sets it to “0”, for all output lines #1 through #4 (at the 4th row in FIG. 17(d)). All the scheduling results are sent to the output schedulers to update the request counters and the grant pointers. Since a request destined for output line #1 is not selected, output controller 31-1 controls grant pointer g1 and the request counters to hold their preceding values. Since a request from input line #2 to output line #2 is selected, output scheduler 31-2 updates grant point g2 to a value indicative of output line #3, decrements the request counter from input line #2 to output line #2, thereby updating it to “0” (at the 2nd row and the 2nd column in FIG. 17(c)). Since a request from input line #3 to output line #3 is selected, output scheduler 31-3 updates grant point g3 to output line #4, and decrements the request counter from input line #3 to output line #3, thereby updating it to “1” (at the 3rd row and the 3rd column in FIG. 17(c)). Since a request from input line #1 to output line #4 is selected, output scheduler 31-4 updates grant point g4 to output line #1, and decrements the request counter from input line #1 to output line #4, thereby updating it to “0” (at the 1st row and the 4th column in FIG. 17(c)).

The conventional scheduler described above is problematic in that as the number of input and output lines increases or as the rate of input and output lines increases, the processing rate of the scheduler decreases, resulting in a lower switch throughput. Specifically, as the number of input and output lines increases, the amount of calculations which the scheduler needs to make greatly increase, and the scheduler finds it difficult to complete its processing within one time slot. As the rate of input and output lines increases, the time of one time slot is reduced, and the scheduler finds it difficult to complete its processing within one time slot.

### SUMMARY OF THE INVENTION

It is an object of the present invention to provide a packet switch scheduling apparatus for quickly establishing a schedule to connect input and output lines in a packet switch.

According to the present invention, the request counting process, the output scheduling process, and the input scheduling process are performed independently of each other and are carried out in respective time slots. Therefore, the amount of processing operations in each of the time slots can be reduced, and scheduling judgments can be made quickly.

Further, according to the present invention, the request counting process, the output scheduling process, and the input scheduling process are performed with respect to each input line or each output line. Consequently, the scheduling function can be distributed among input buffers.

The scheduling process may be first performed on the input lines, and if a plurality of output lines are overlappingly selected according to the scheduling results, then one of the selected output lines may be selected.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram of an overall arrangement of a general input-buffered packet switch;

FIG. 2 is a block diagram of a scheduler according to a first embodiment of the present invention;

FIG. 3 is a sequence diagram of a processing operation of the scheduler shown in FIG. 2;

FIG. 4 is a flowchart of the processing operation of the scheduler shown in FIG. 2;

FIGS. 5(a) through 5(c) are diagrams showing a specific example of operation (step 1) of the scheduler shown in FIG. 2;

FIGS. 6(a) through 6(c) are diagrams showing a specific example of operation (step 2) of the scheduler shown in FIG. 2;

FIGS. 7(a) through 7(c) are diagrams showing a specific example of operation (step 3) of the scheduler shown in FIG. 2;

FIG. 8 is a block diagram of a scheduler according to a second embodiment of the present invention;

FIGS. 9(a) through 9(d) are diagrams showing a specific example of operation (step 1) of the scheduler shown in FIG. 8;

FIGS. 10(a) through 10(d) are diagrams showing a specific example of operation (step 2) of the scheduler shown in FIG. 8;

FIGS. 11(a) through 11(d) are diagrams showing a specific example of operation (step 3) of the scheduler shown in FIG. 8;

FIG. 12 is a block diagram of a conventional scheduler;

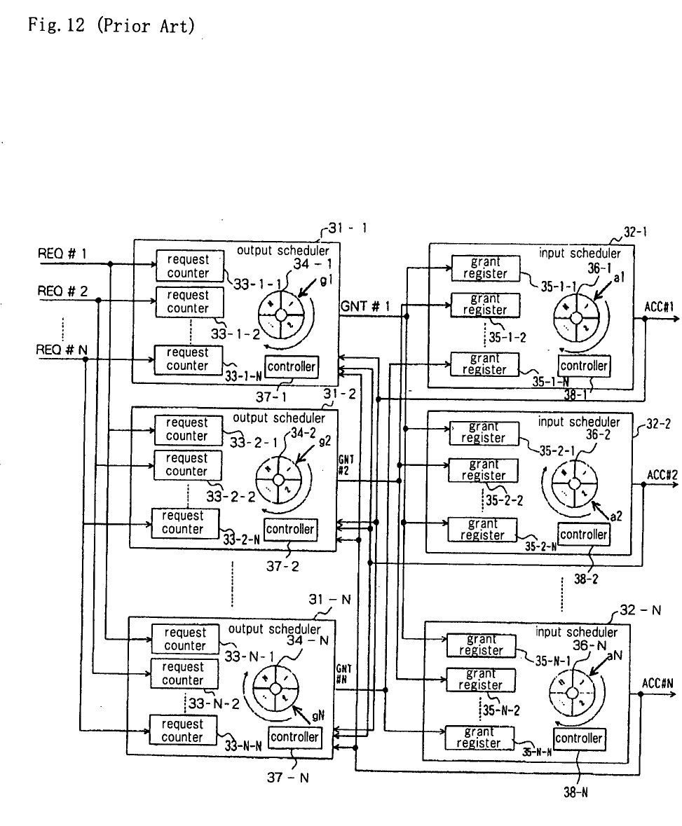

FIGS. 13(a) and 13(b) are sequence diagrams of a processing operation of the scheduler shown in FIG. 12;

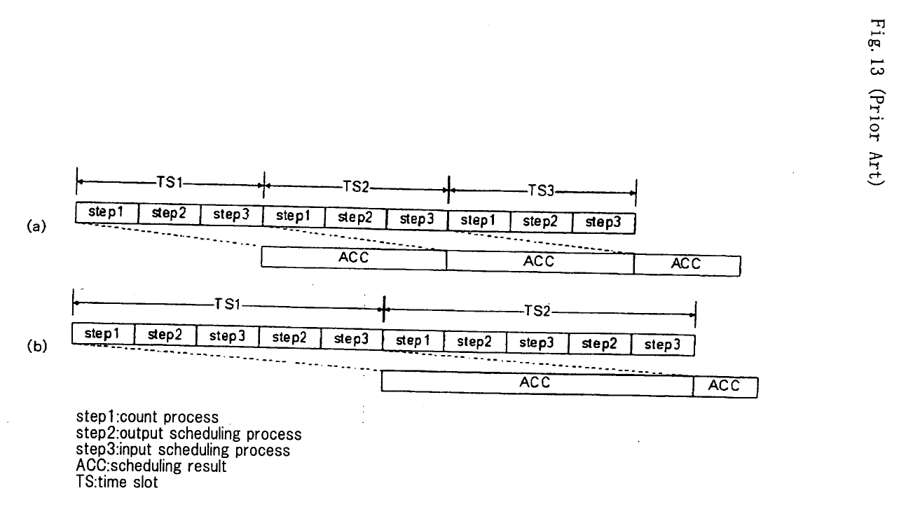

FIG. 14 is a flowchart of the processing operation of the scheduler shown in FIG. 12;

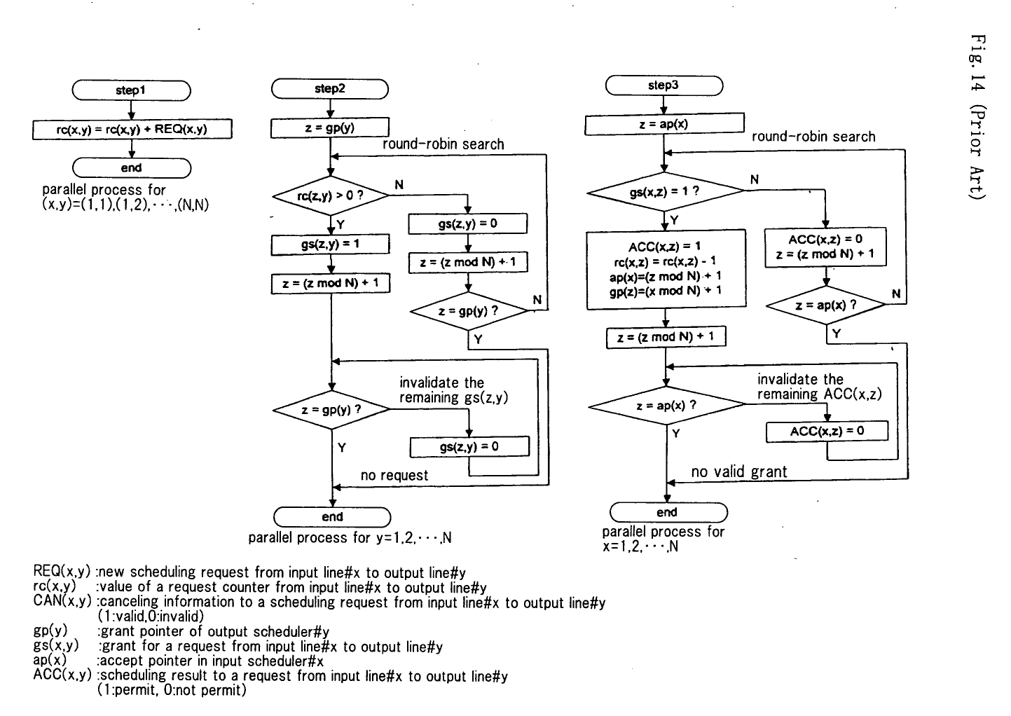

FIGS. 15(a) through 15(c) are diagrams showing a specific example of operation (step 1) of the scheduler shown in FIG. 12;

FIGS. 16(a) through 16(c) are diagrams showing a specific example of operation (step 2) of the scheduler shown in FIG. 12; and

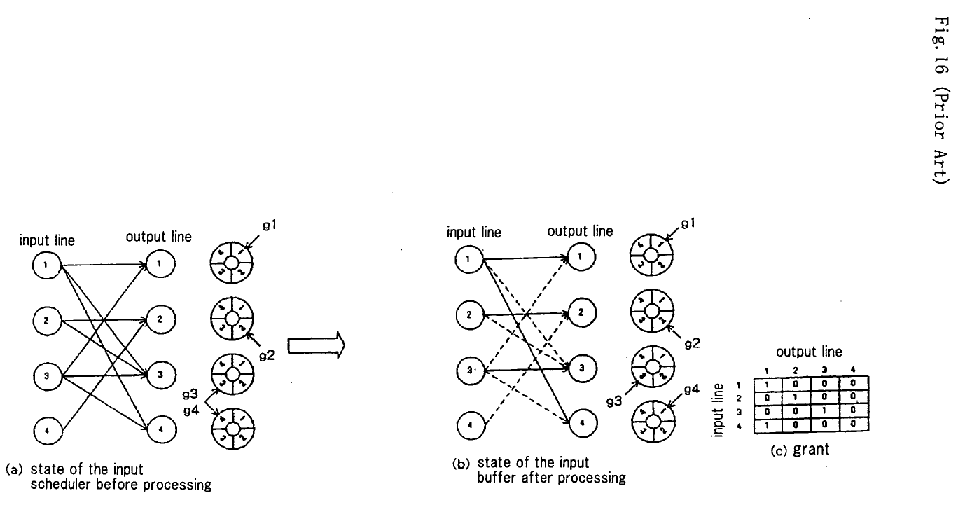

FIGS. 17(a) through 17(c) are diagrams showing a specific example of operation (step 3) of the scheduler shown in FIG. 12.

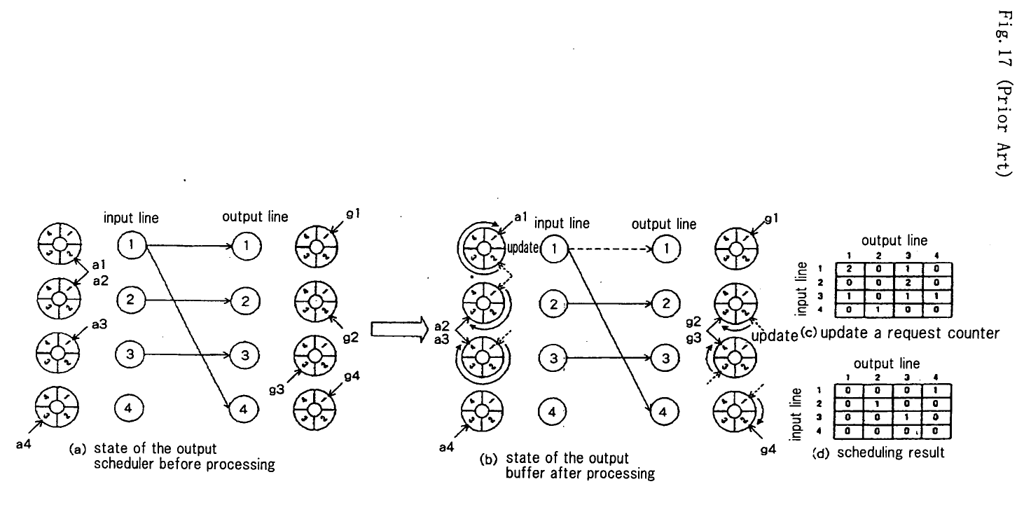

### DETAILED DESCRIPTION OF THE PREFERRED EMBODIMENTS

### 1st Embodiment

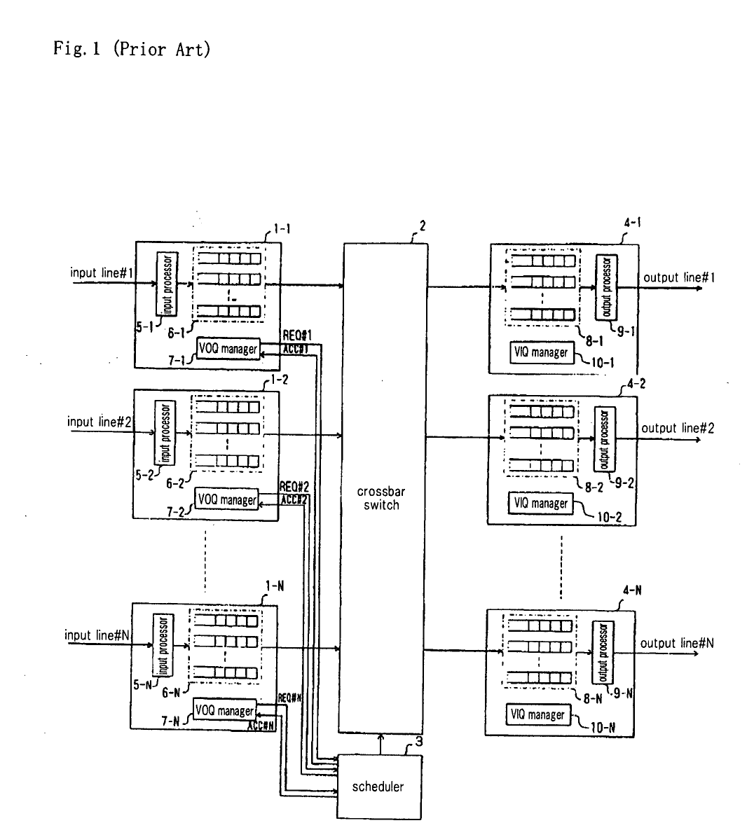

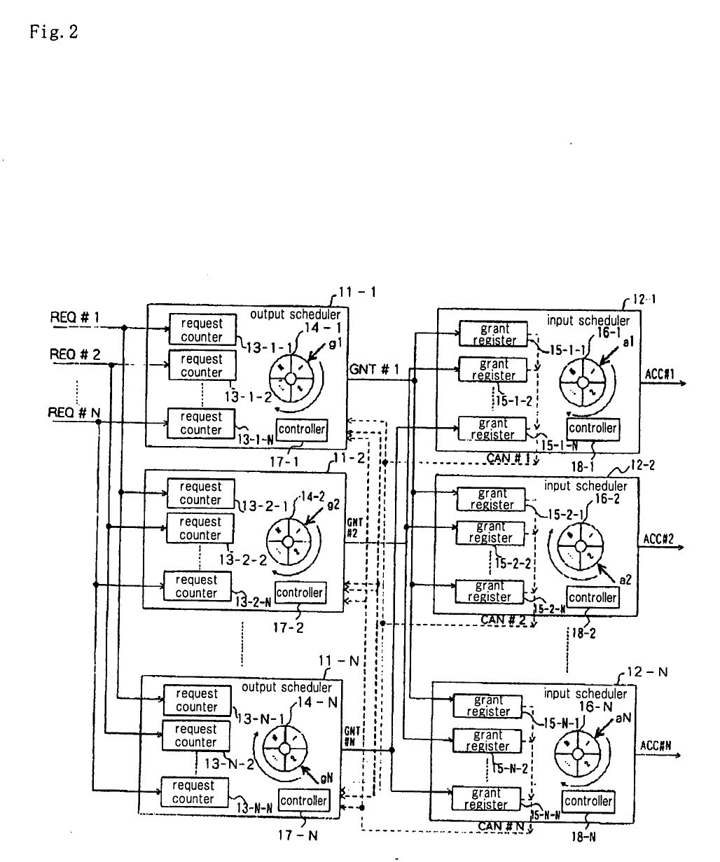

FIG. 2 shows in block form a scheduler according to a first embodiment of the present invention, for use as scheduler 3 of the packet switch shown in FIG. 1. As shown in FIG. 2, scheduler 3 comprises N output schedulers 11-1 through 11-N and N input schedulers 12-1 through 12-N.

Output scheduler 11-1 comprises request counters 13-1-1 through 13-1-N for counting requests from all input lines #1 through #N to output line #1 for the respective input lines, grant pointer g1 (14-1) for indicating a leading end of the round-robin rules, and controller 17-1 for controlling request counters 13-1-1 through 13-1-N and grant pointer g1 (14-1). Output schedulers 11-2 through 11-N comprise request counters 13-2-1 through 13-N-N for counting requests from all input lines #1 through #N to corresponding output lines for the respective input lines, grant pointers g2 through gN (14-2 through 14-N) for indicating leading ends of the round-robin rules, and controllers 17-2 through 17-N for controlling request counters 13-2-1 through 13-N-N and grant pointers g2 through gN (14-2 through 14-N). Input scheduler 12-1 comprises grant registers GS (15-1-1 through 15-1-N) for extracting grants for input line #1 from selected results of all output schedulers 11-1 through 11-N and holding the extracted grants for the respective output lines, accept pointer a1 (16-1) for indicating a leading end of the round-robin rules, and controller 18-1 for controlling grant registers GS (15-1-1 through 15-1-N) and accept pointer a1 (16-1). Input schedulers 12-2 through 12-N comprise grant registers GS (15-2-1 through 15-N-N) for receiving selected results of all output schedulers 11-1 through 11-N, accept pointers a2 through aN (16-2 through 16-N) for indicating leading ends of the round-robin rules, and controllers 18-2 through 18-N for controlling grant registers GS (15-2-1 through 15-N-N) and accept pointers a2 through aN (16-2 through 16-N).

Controller 17-1 of output scheduler 11-1 extracts requests whose destinations are designated as output line #1 from the scheduling requests input from the VOQ managers of all input lines #1 through #N, and counts requests for the respective input lines by request counters 13-1-1 through 13-1-N. Controller 17-1 extracts cancels whose destinations are designated as output line #1 from canceling information input from input schedulers 12-1 through 12-N, and increases the values of request counters 13-1-1 through 13-1-N for the respective input lines. Controller 17-1 selects one of the input lines for which the number of requests counted by request counters 13-1-1 through 13-1-N is 1 or more, according to the round-robin rules with top priority given to grant pointer g1 (14-1), and decrements by 1 the request counter of the selected input line. Controller 17-1 outputs the number of the selected input line as granted to input schedulers 12-1 through 12-N, and updates grant pointer g1 (14-1) to a value indicative of an input line next to the selected input line. For example, if input line #1 is selected, then controller 17-1 updates grant pointer g1 (14-1) to a value indicative of input line #2, and if input line #N is selected, then controller 17-1 updates grant pointer g1 (14-1) to a value indicative of input line #1.

Controller 17-2 of output scheduler 11-1 extracts requests whose destinations are designated as output line #2 from the scheduling requests input from the VOQ managers of all input lines #1 through #N, and counts requests for the respective input lines by request counters 13-2-1 through 13-2-N. Controller 17-2 extracts cancels whose destinations are designated as output line #2 from canceling information input from input schedulers 12-1 through 12-N, and increases the values of request counters 13-2-1 through 13-2-N for the respective input lines. Controller 17-2 selects one of the input lines for which the number of requests counted by request counters 13-2-1 through 13-2-N is 1 or more, according to the round-robin rules with top priority given to grant pointer g2 (14-2), and decrements by 1 the request counter of the selected input line. Controller 17-2 outputs the number of the selected input line as granted to input schedulers 12-1 through 12-N, and updates grant pointer g2 (14-2) to a value indicative of an input line next to the selected input line.

Controllers 17-3 through 17-N of output schedulers 11-3 through 11-N also perform the same controlling process as controller 17-1 of output scheduler 11-1 and controller 17-2 of output scheduler 11-2.

Controller 18-1 of input scheduler 12-1 extracts grants whose sources are designated as input line #1 from the grants input from all output schedulers 11-1 through 11-N, and stores the extracted grants in grant registers 15-1-1 through 15-1-N for the respective output lines. If there are not corresponding grants, then controller 18-1 clears the grant registers (no grants). Controller 18-1 selects one of the output lines for which grants are included in the grant registers, according to the round-robin rules with top priority given to accept pointer a1 (16-1), and outputs the number of the selected output line as a scheduling result to VOQ manager 7-1 of input buffer 1-1. Controller 18-1 updates accept pointer a1 (16-1) to a value indicative of an output line next to the selected output line. For example, if output line #1 is selected, then controller 18-1 updates accept pointer a1 (16-1) to a value indicative of output line #2, and if output line #N is selected, then controller 18-1 updates accept pointer a1 (16-1) to a value indicative of output line #1. If none of grant registers 15-1-1 through 15-1-N store grant information, then the scheduling result is output as unconnected, and accept pointer a1 (16-1) holds the preceding value. If the grant registers store grants, but the grants have not been selected in the above selecting process, then they are output as canceling information to the corresponding output schedulers.

Controller 18-2 of input scheduler 12-2 extracts grants whose sources are designated as input line #2 from the grants input from all output schedulers 11-1 through 11-N, and stores the extracted grants in grant registers 15-2-1 through 15-2-N for the respective output lines. If there are no corresponding grants, then controller 18-2 clears the grant registers (no grants). Controller 18-2 selects one of the output lines for which grants are included in the grant registers, according to the round-robin rules with top priority given to accept pointer a2 (16-2), and outputs the number of the selected output line as a scheduling result to VOQ manager 7-1 of input buffer 1-2. Controller 18-2 updates accept pointer a2 (16-2) to a value indicative of an output line next to the selected output line. If none of grant registers 15-1-1 through 15-1-N store grant information, then the scheduling result is output as unconnected, and accept pointer a2 (16-2) holds the preceding value. If the grant registers store grants, but the grants have not been selected in the above selecting process, then they are output as canceling information to the corresponding output schedulers.

Controllers 18-3 through 18-N of input schedulers 12-3 through 12-N also perform the same controlling process as controller 18-1 of input scheduler 12-1 and controller 1-8-2 of input scheduler 12-2.

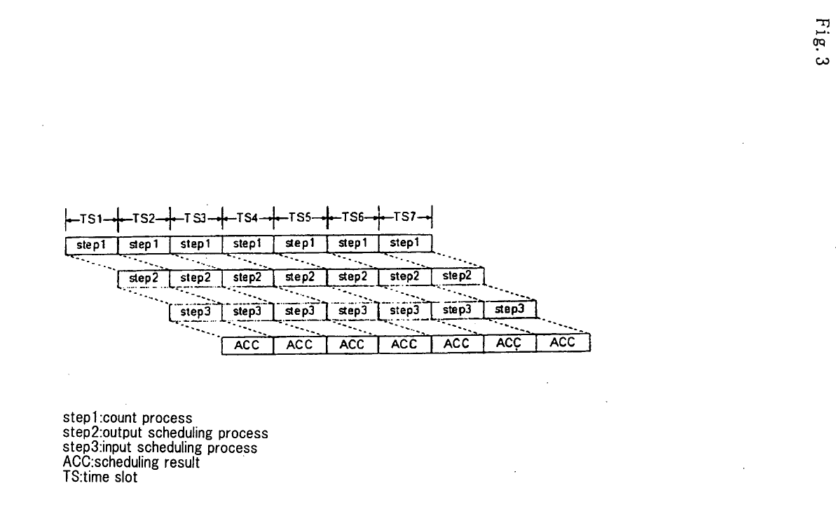

Output schedulers 11-1 through 11-N and input schedulers 12-1 through 12-N operate independently of each other, and a request counting process (step 1), an output scheduling process (step 2), and an input scheduling process (step 3) are performed once in one time slot, as shown in FIG. 3.

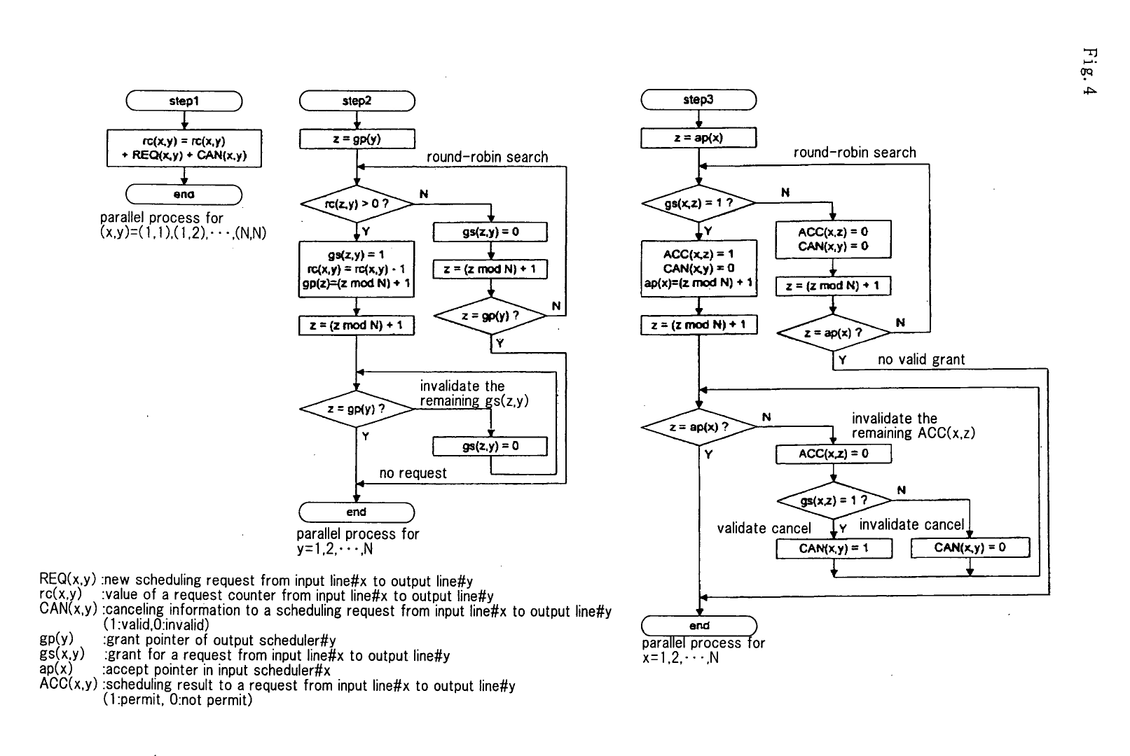

FIG. 4 is a flowchart of the request counting process (step 1), the output scheduling process (step 2), and the input scheduling process (step 3).

Operation of the scheduler according to the first embodiment where the number N of input/output lines is 4 will be described below with reference to FIGS. 2, 4 and 7(a)-7(d).

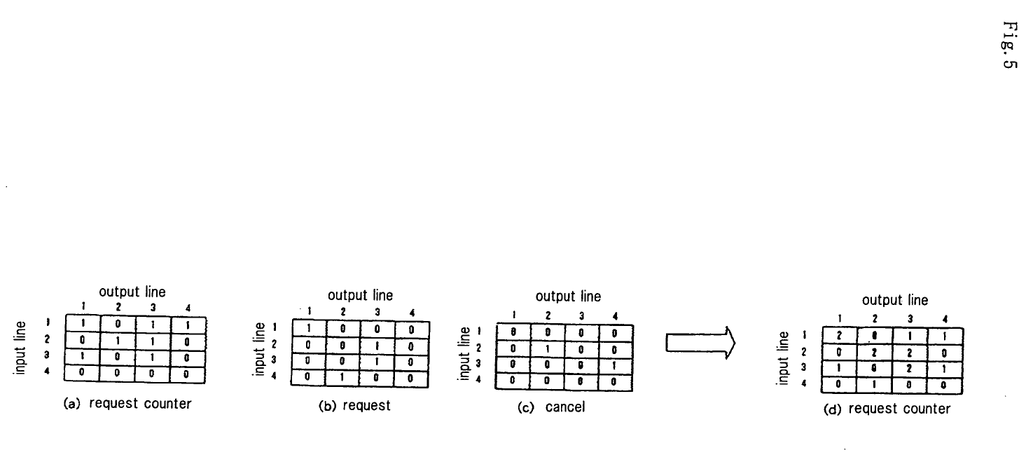

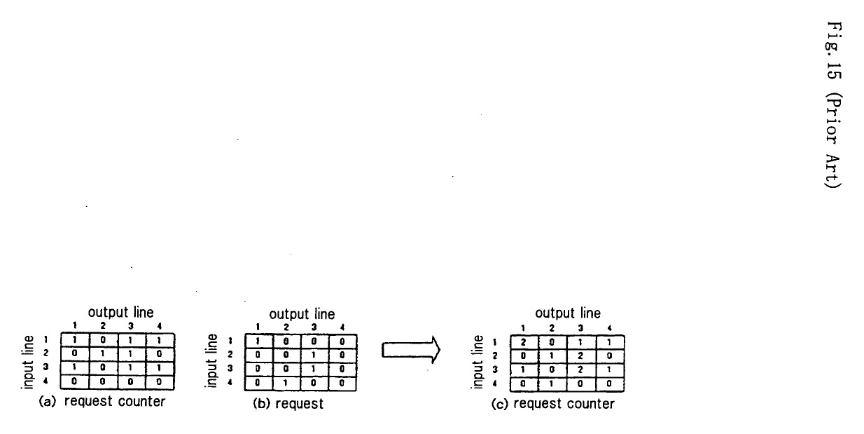

In step 1, output schedulers 11-1 through 11-4 count scheduling requests from input buffers 1-1 through 1-4 to output buffers 4-1 through 4-4 (FIGS. 5(a) through 5(c)). FIG. 15(a) shows the values of request counters 13-1-1 through 13-4-4 before step 1 is executed. FIG. 5(b) shows new scheduling requests REQ#1 through REQ#4 input from input buffers 1-1 through 14. FIG. 5(c) shows canceling information CAN#1 through CAN#4 input from input schedulers 12-1 through 12-4. FIG. 5(d) shows the values of request counters 13-1-1 through 13-4-4 after step 1 is executed. With respect to the combination of input line #1 and output line #1, the value “1” of the request counter (at the 1st row and the 1st column in FIG. 5(a)), the value “1” of the request (at the 1st row and the 1st column in FIG. 5(b)), and the value “0” of the cancel (at the 1st row and the 1st column in FIG. 5(c)) are added to each other, thereby updating the value of the request counter (at the 1st row and the 1st column in FIG. 5(d)) to “2”. With respect to the combination of input line #1 and output line #2, the value “0” of the request counter (at the 1st row and the 2nd column in FIG. 5(a)), the value “0” of the request (at the 1st row and the 2nd column in FIG. 5(b)), and the value “0” of the cancel (at the 1st row and the 2nd column in FIG. 5(c)) are added to each other, thereby updating the value of the request counter (at the 1st row and the 2nd column in FIG. 5(d)) to “0”. Similarly, with respect to all combinations of the input lines and the output lines, the values of the request counters are updated.

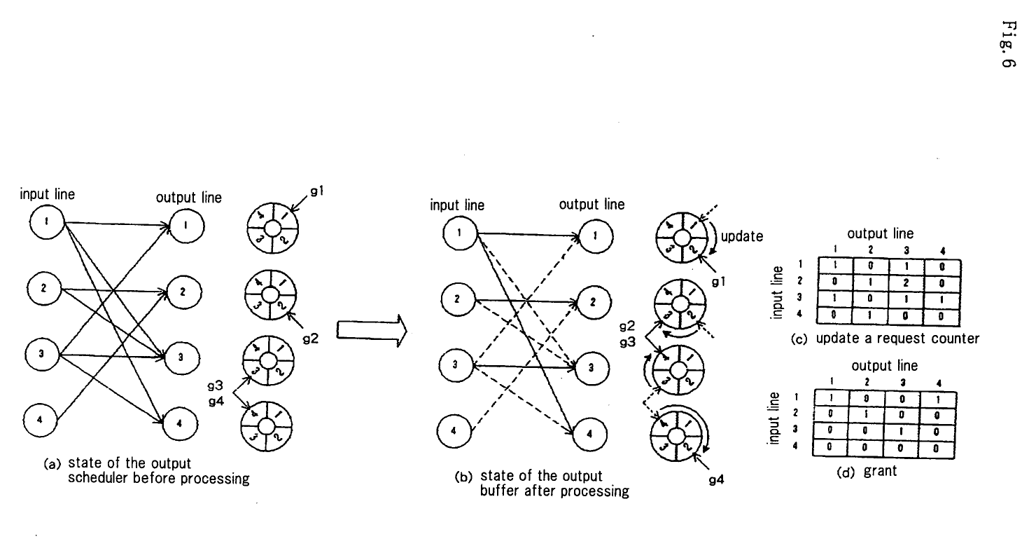

In step 2, output schedulers 11-1 through 11-4 select a request for each output line from the requests whose destinations are designated as output lines #1 through #4, according to the round-robin rules (FIGS. 6(a) through 6(d)). FIG. 6(a) shows requests from the input lines to the output lines and to grant pointers before step 2 is carried out, and FIG. 6(b) shows selected requests to the output lines and grant pointers after step 2 is carried out. FIG. 6(c) shows the values of the request counters after step 2 is carried out, and FIG. 6(d) shows grants output from output schedulers 11-1 through 11-4 after step 2 is carried out. Controller 17-1 of output scheduler 11-1 searches for input lines for which the number of requests counted by the request counter is 1 or more, from input line #1 indicated by grant pointer g1 (14-1). Since the request counter from input line #1 has a count of 2, output scheduler 11-1 selects input line #1 as a candidate that can be connected to output line #1. Output scheduler 11-1 updates the value of the grant pointer to a value indicative of input line #2 according to the round-robin rules, and decrements by 1 the value of request counter 13-1-1 from selected input line #1, thereby updating it to “1” (at the 1st row and the 1st column in FIG. 6(c)). Output scheduler 11-1 makes grants output to input scheduler 12-1 valid, i.e., sets them to “1” (at the 1st row and the 1st column in FIG. 6(d)), and makes grants output to input schedulers 12-2, 12-3, 12-4 invalid, i.e., sets them to “0” (at the 2nd row and the 1st column, the 3rd row and the 1st column, and the 4th row and the 1st column in FIG. 6(d)). Controller 17-2 of output scheduler 11-2 searches for input lines for which the number of requests counted by the request counter is 1 or more, from input line #2 indicated by grant pointer g2 (14-2). Since the request counter from input line #2 has a count of 2, output scheduler 11-2 selects input line #2 as a candidate that can be connected to output line #2. Controller 17-2 of output scheduler 11-2 updates the value of the grant pointer to a value indicative of input line #3 according to the round-robin rules, and decrements the value of request counter 13-1-2 from selected input line #2, thereby updating it to “1” (at the 2nd row and the 2nd column in FIG. 6(c)). Output scheduler 11-2 makes grants output to input scheduler 12-2 valid, i.e., sets them to “1” (at the 2nd row and the 2nd column in FIG. 6(d)), and makes grants output to input schedulers 12-1, 12-3, 12-4 invalid, i.e., sets them to “0” (at the 1st row and the 2nd column, the 3rd row and the 2nd column, and the 4th row and the 2nd column in FIG. 6(d)).

Controller 17-3 of output scheduler 11-3 searches for input lines for which the number of requests counted by the request counters is 1 or more, from input line #3 indicated by grant pointer g3 (14-3). Since the request counter from input line #3 has a count of 2, controller 17-3 selects input line #3 as a candidate that can be connected to output line #3. Controller 17-3 updates the value of the grant pointer to a value indicative of input line #4 according to the round-robin rules, and decrements the value of request counter 13-1-3 from selected input line #3, thereby updating it to “1” (at the 3rd row and the 3rd column in FIG. 6(c)). Controller 17-3 makes grants output to input scheduler 12-3 valid, i.e., sets them to “1” (at the 3rd row and the 3rd column in FIG. 6(d)), and makes grants output to input schedulers 12-1, 12-2, 12-4 invalid, i.e., sets them to “0” (at the 1st row and the 3rd column, the 2nd row and the 3rd column, and the 4th row and the 3rd column in FIG. 6(d)). Controller 17-4 of output scheduler 11-4 searches for input lines for which the number of requests counted by the request counters is 1 or more, from input line #4 indicated by grant pointer g4 (14-4). Since the request counter from input line #4 has a count of 0, input line #4 cannot be selected as a candidate that can be connected to output line #4. The number of requests counted by the request counter from input line #1, as it is referred to, according to the round-robin rules is 1. Output scheduler 11-4 thus selects input line #1 as a candidate that can be connected to output line #4. Controller 17-4 updates the value of the grant pointer to a value indicative of input line #2 according to the round-robin rules, and decrements the value of request counter 13-4-1 from selected input line #1, thereby updating it to “0” (at the 1st row and the 4th column in FIG. 6(c)). Controller 17-4 makes grants output to input scheduler 12-1 valid, i.e., sets them to “1” (at the 1st row and the 4th column in FIG. 6(d)), and makes grants output to input schedulers 12-2, 12-3, 12-4 invalid, i.e., sets them to “0” (at the 2nd row and the 4th column, the 3rd row and the 4th column, and the 4th row and the 4th column in FIG. 6(d)).

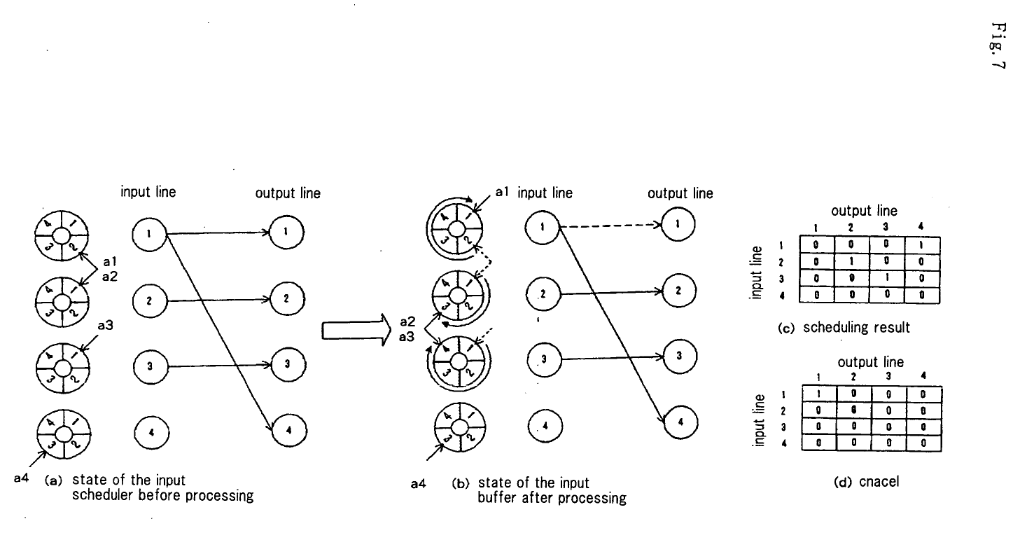

In step 3, input schedulers 12-1 through 12-4 select a grant for each input line from valid grants input from output schedulers 11-1 through 11-4 according to the round-robin rules (FIGS. 7(a) through 7(d)). FIG. 7(a) shows valid grants from the input lines to the output lines and accept pointers before step 3 is carried out, and FIG. 7(b) shows selected grants and accept pointers after step 3 is carried out. FIG. 7(c) shows scheduling results after step 3 is carried out, and FIG. 7(d) shows canceling information output from input schedulers 12-1 through 12-4 after step 3 is carried out. Controller 18-1 of Input scheduler 12-1 receives grants input from respective output schedulers 11-1 through 11-4 by grant registers 15-1-1 through 15-1-4. Controller 18-1 refers to grant-register 15-1-2 for output line #2 indicated by accept pointer a1 (16-1), and it is invalid, i.e., it is set to “0”. Controller 18-1 refers to grant register 15-1-3 for next output line #3 according to the round-robin rules, and it is invalid, i.e., it is set to “0”. Input scheduler 12-1 refers to grant register 15-1-4 for next output line #4, and it is valid, i.e., it is set to “1”. Therefore, controller 18-1 selects output line #4 as a line to which packets can be output. Controller 18-1 updates the value of accept pointer a1 to a value indicative of output line #1 according to the round-robin rules. Controller 18-1 makes a scheduling result ACC#1 output to input buffer 1-1 valid, i.e., sets it to “1”, only for output line #4 (at the 1st row and 4th column in FIG. 7(c)), and makes it invalid, i.e., sets it to “0”, for output lines #1, #2, #3 (at the 1st row and the 1st column, the 1st row and the 2nd column, and the 1st row and the 3rd column in FIG. 7(c)). Controller 18-1 outputs information that though the grant register is valid, the grant of output line #1 which is not selected is canceled, to output scheduler 11-1 (at the 1st row and the 1st column in FIG. 7(d)). Controller 18-2 of Input scheduler 12-2 receives grants input from respective output schedulers 11-1 through 11-4 by grant registers 15-2-1 through 15-24. Controller 18-2 refers to grant register 15-2-1 for output line #1 indicated by accept pointer a2 (16-2), and it is invalid, i.e., it is set to “0”. Controller 18-2 refers to grant register 15-2-2 for next output line #2 according to the round-robin rules, and it is valid, i.e., it is set to “1”. Therefore, input scheduler 12-2 selects output line #2 as a line-to which packets can be output. Controller 18-2 updates the value of accept pointer a2 to a value indicative of output line #3 according to the round-robin rules. Controller 18-2 makes a scheduling result ACC#2 output to input buffer 1-2 valid, i.e., sets it to “1”, only for output line #2 (at the 2nd row and 2nd column in FIG. 7(c)), and makes it invalid, i.e., sets it to “0”, for output lines #1, #3, #4 (at the 2nd row and the 1st column, the 2nd row and the 3rd column, and the 2nd row and the 4th column in FIG. 7(c)). Controller 18-3 of input scheduler 12-3 receives grants input from respective output schedulers 11-1 through 11-4 by grant registers 15-3-1 through 15-34. Controller 18-3 refers to grant register 15-3-1 for output line #1 indicated by accept pointer a3 (16-3), and it is invalid, i.e., it is set to “0”. Controller 18-3 refers to grant register 15-3-2 for next output line #2 according to the round-robin rules, and it is invalid, i.e., it is set to “0”. Controller 18-3 refers to grant register 15-3-3 for next output line #3, and it is valid, i.e., it is set to “1”. Therefore, controller 18-3 selects output line #3 as a line that packets can be output. Controller 18-3 updates the value of accept pointer a3 to a value indicative of output line #4 according to the round-robin rules. Controller 18-3 makes a scheduling result ACC#3 output to input buffer 1-3 valid, i.e., sets it to “1”, only for output line #3 (at the 3rd row and 3rd column in FIG. 7(c)), and makes it invalid, i.e., sets it to “0”, for output lines #1, #2, #4 (at the 3rd row and the 1st column, the 3rd row and the 2nd column, and the 3rd row and the 4th column in FIG. 7(c)). Controller 18-4 of input scheduler 12-4 receives grants input from respective output schedulers 11-1 through 11-4 by grant registers 15-4-1 through 15-4-4. Controller 18-4 refers to grant register 15-4-3 for output line #3 indicated by accept pointer a4 (16-4), and it is invalid, i.e., it is set to “0”. Controller 18-4 refers to grant registers 15-4-4, 15-4-1, 15-4-2 for next output lines #4, #2, #1 according to the round-robin rules, and all of them are invalid, i.e., all of them are set to “0”. Therefore, controller 18-4 judges that there is no line that packets can be output, and controls accept pointer a4 (36-4) to hold the preceding value. Controller 18-4 makes a scheduling result ACC#4 output to input buffer 14 invalid, i.e., sets it to “0”, for all output lines #1 through #4 (at the 4th row in FIG. 7(c)).

According to the first embodiment, the request counting process (FIGS. 5(a) through 5(d)), the output scheduling process (FIGS. 6(a) through 6(d)), and the input scheduling process (FIGS. 7(a) through 7(d)) are performed independently of each other and are carried out in respective time slots. Therefore, the amount of processing operations in each of the time slots is reduced.

### 2nd Embodiment

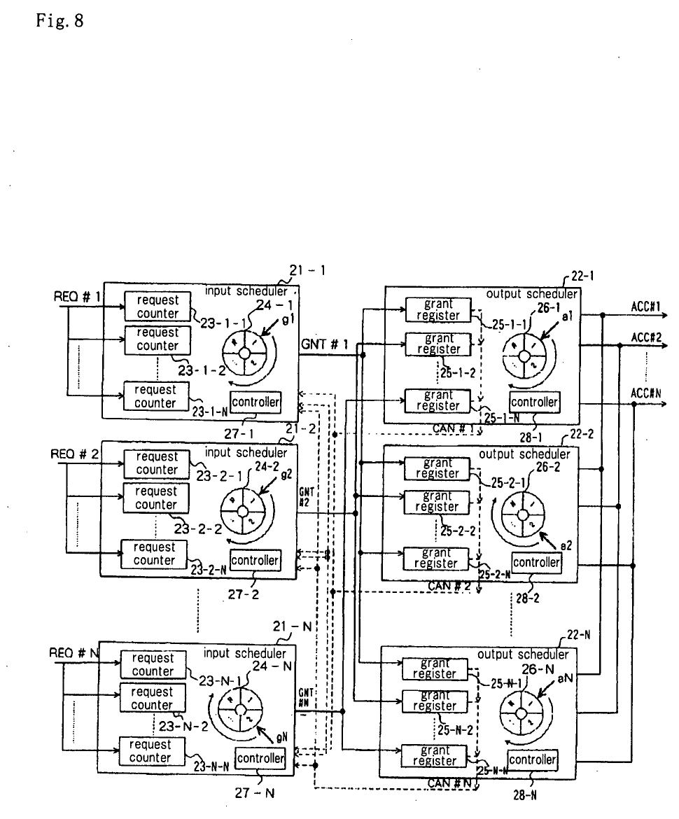

FIG. 8 shows in block form a scheduler according to a second embodiment of the present invention. As shown in FIG. 8, the scheduler comprises N input schedulers 21-1 through 21-N and N output schedulers 22-1 through 22-N.

Input scheduler 21-1 comprises request counters 23-1-1 through 23-1-N for counting requests from input line #1 to output lines #1 through #N for the respective output lines, grant pointer g1 (24-1) for indicating a leading end of the round-robin rules, and controller 27-1 for controlling request counters 23-1-1 through 23-1-N and grant pointer g1 (24-1). Input schedulers 21-2 through 21-N comprise request counters 23-2-1 through 23-N-N for counting requests from corresponding input lines to output lines #1 through #N for the respective output lines, grant pointers g2 through gN (24-2 through 24-N) for indicating leading ends of the round-robin rules, and controllers 27-2 through 27-N for controlling request counters 23-2-1 through 23-N-N and grant pointers g2 through gN (24-2 through 24-N). Output scheduler 22-1 comprises grant registers 25-1-1 through 25-1-N for extracting grants for input line #1 from selected results of all input schedulers-21-1 through 21-N and for holding the extracted grants for the respective input lines, accept pointer a1 (26-1) for indicating a leading end of the round-robin rules, and controller 28-1 for controlling grant registers 25-1-1 through 25-1-N and accept pointer a1 (26-1). Output schedulers 22-2 through 22-N comprise grant registers 25-2-1 through 25-N-N for receiving selected results of all input schedulers 21-1 through 21-N, accept pointers a2 through aN (26-2 through 26-N) for indicating leading ends of the round-robin rules, and controllers 28-2 through 28-N for controlling grant registers 25-2-1 through 25-N-N and accept pointers a2 through aN (26-2 through 26-N).

Controller 27-1 of input scheduler 21-1 counts scheduling requests input from the VOQ manager of input line #1 for the respective output lines by request counters 23-1-1 through 23-1-N. Controller 27-1 extracts cancels whose sources are designated as input line #1 from canceling information input from output schedulers 22-1 through 22-N, and increases the values of request counters 23-1-1 through 23-1-N for the respective output lines. Controller 27-1 selects one of the output lines for which the number of requests counted by request counters 23-1-1 through 23-1-N is 1 or more, according to the round-robin rules with top priority given to grant pointer g1 (24-1), and decrements by 1 the request counter of the selected input line. Controller 27-1 outputs the number of the selected input line as granted to output schedulers 22-1 through 22-N, and updates grant pointer g1 (24-1) to a value indicative of an input line next to the selected output line. For example, if output line #1 is selected, then controller 27-1 updates grant pointer g1 (24-1) to a value indicative of input line #2, and if output line #N is selected, then controller 27-1 updates grant pointer g1 (24-1) to a value indicative of output line #1.

Controller 27-2 of input scheduler 21-2 counts scheduling requests input from the VOQ manager for input line #2 for the respective output lines by request counters 23-2-1 through 23-2-N. Controller 27-2 extracts cancels whose sources are designated as input line #2 from canceling information input from output schedulers 22-1 through 22-N, and increases the values of request counters 23-2-1 through 23-2-N for the respective output lines. Controller 27-2 selects one of the output lines for which the number of requests counted by request counters 23-2-1 through 23-2-N is 1 or more, according to the round-robin rules with top priority given to grant pointer g2 (24-2), and decrements by 1 the request counter of the selected input line. Controller 27-2 outputs the number of the selected input line, as granted, to output schedulers 22-1 through 22-N, and updates grant pointer g2 (24-2) to a value indicative of an input line next to the selected output line.

Controllers 27-3 through 27-N of input schedulers 21-3 through 21-N also perform the same controlling process as controller 27-1 of input scheduler 21-1 and controller 27-2 of input scheduler 21-2.

Controller 28-1 of output scheduler 22-1 extracts grants whose destinations are designated as output line #1 from the grants output from all input schedulers 21-1 through 21-N, and stores the extracted grants in grant registers 25-1-1 through 25-1-N for the respective input lines. If there are no corresponding grants, then controller 28-1 clears the grant registers (no grants). Controller 28-1 selects one of the input lines for which grants are included in grant registers 25-1-1 through 25-1-N, according to the round-robin rules with top priority given to accept pointer a1 (26-1). Controller 28-1 outputs the number of the selected input line as a scheduling result to the VOQ manager of output buffer 4-1, and updates accept pointer a1 (26-1) to a value indicative of an output line next to the selected output line. For example, if input line #1 is selected, then controller 28-1 updates accept pointer a1 (26-1) to a value indicative of input line #2, and if input line #N is selected, then controller 28-1 updates accept pointer a1 (26-1) to a value indicative of input line #1. If all grant registers 25-1-1 through 25-1-N store no grant information, then the scheduling result is output as unconnected, and accept pointer a1 (26-1) holds the preceding value. If the grant registers store grants, but the grants have not been selected in the above selecting process, then they are output as canceling information to the corresponding input schedulers.

Controller 28-2 of output scheduler 22-2 extracts grants whose destinations are designated as output line #2 from the grants output from all input schedulers 21-1 through 21-N, and stores the extracted grants in grant registers 25-2-1 through 25-2-N for the respective input lines. If there are no corresponding grants, then controller 28-2 clears the grant registers (no grants). Controller 28-2 selects one of the input lines for which grants are included in grant registers 25-2-1 through 25-2-N, according to the round-robin rules with top priority given to accept pointer a2 (26-2). Controller 28-2 outputs the number of the selected input line as a scheduling result to the VOQ manager of output buffer 4-2, and updates accept pointer a2 (26-2) to a value indicative of an output line next to the selected output line. If none of grant registers 25-2-1 through 25-2-N store grant information, then the scheduling result is output as unconnected, and accept pointer a1 (26-2) holds the preceding value. If the grant registers store grants, but the grants have not been selected in the above selecting process, then they are output as canceling information to the corresponding input schedulers.

Controllers 28-3 through 28-N of output schedulers 22-3 through 22-N also perform the same controlling process as controller 28-1 of output scheduler 22-1 and controller 28-2 of output scheduler 22-2.

Input schedulers 21-1 through 21-N and output schedulers 22-1 through 22-N operate independently of each other, and each of their processing operations is performed once in a one time slot.

Operation of the scheduler according to the second embodiment where the number N of input/output lines is 4 will be described below with reference to FIGS. 8 and 9(a)-9(d) and 11(a) through 11(d).

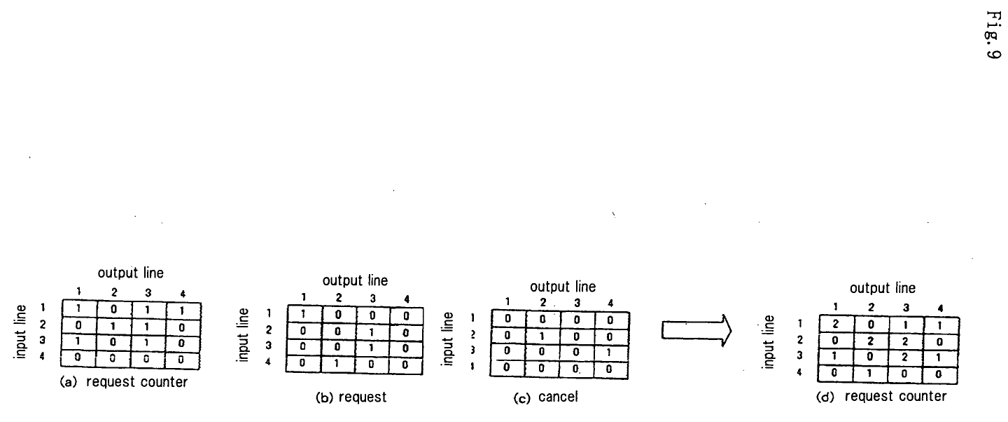

In step 1, input schedulers 21-1 through 214 count scheduling requests from input buffers 1-1 through 1-4 to output buffers 4-1 through 4-4 (FIGS. 9(a) through 9(d)). FIG. 9(a) shows the values of request counters 23-1-1 through 23-4-4 before step 1 is executed. FIG. 9(b) shows new scheduling requests REQ#1 through REQ#4 input from input buffers 1-1 through 1-4. FIG. 9(c) shows canceling information CAN#1 through CAN#4 input from output schedulers 22-1 through 22-4. FIG. 9(d) shows the values of request counters 23-1-1 through 23-4-4 after step 1 is executed. With respect to the combination of input line #1 and output line #1, the value “1” of the request counter (at the 1st row and the 1st column in FIG. 9(a)), the value “1” of the request (at the 1st row and the 1st column in FIG. 9(b)), and the value “0” of the cancel (at the 1st row and the 1st column in FIG. 9(c)) are added to each other, thereby updating the value of the request counter (at the 1st row and the 1st column in FIG. 9(d)) to “2”. With respect to the combination of input line #1 and output line #2, the value “0” of the request counter (at the 1st row and the 2nd column in FIG. 9(a)), the value “0” of the request (at the 1st row and the 2nd column in FIG. 9(b)), and the value “0” of the cancel (at the 1st row and the 2nd column in FIG. 9(c)) are added to each other, thereby updating the value of the request counter (at the 1st row and the 2nd column in FIG. 9(d)) to “0”. Similarly, with respect to all combinations of the input lines and the output lines, the values of the request counters are updated.

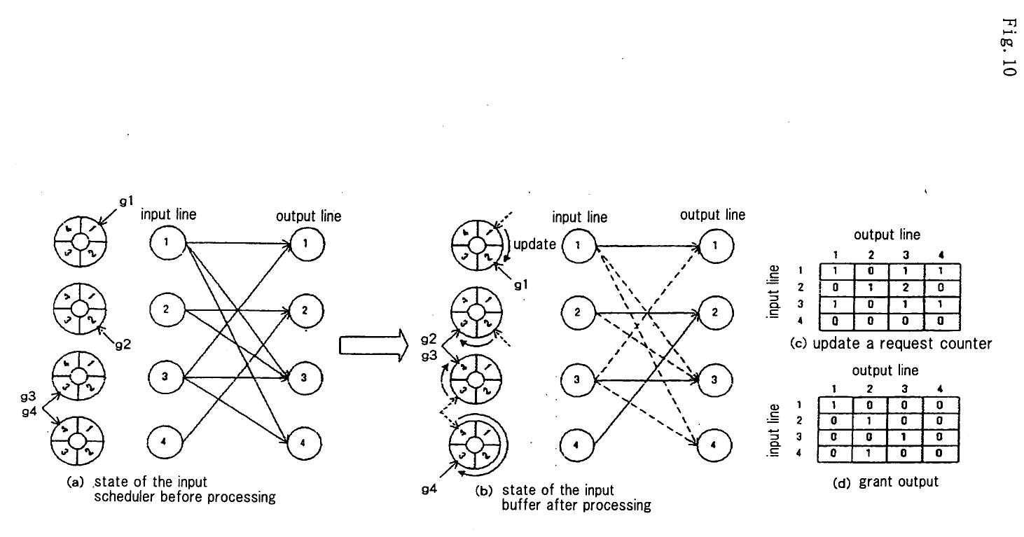

In step 2, input schedulers 21-1 through 21-4 select a request for each output line from the requests whose destinations are designated as output lines #1 through #4, respectively, according to the round-robin rules (FIGS. 10(a) through 10(d)). FIG. 10(a) shows requests from the input lines to the output lines and grant pointers before step 2 is carried out, and FIG. 10(b) shows selected requests to the output lines and grant pointers after step 2 is carried out. FIG. 10(c) shows the values of the request counters after step 2 is carried out, and FIG. 10(d) shows grants output from input schedulers 21-1 through 21-4 after step 2 is carried out. Controller 28-1 of Input scheduler 21-1 searches for output lines for which the number of requests counted by the request counters is 1 or more, from output line #1 indicated by grant pointer g1 (24-1). Since the request counter from output line #1 has a count of 2, controller 28-1 selects output line #1 as a candidate that can be connected to input line #1. Controller 28-1 updates the value of the grant pointer to a value indicative of input line #2 according to the round-robin rules, and decrements by 1 the value of request counter 23-1-1 to selected output line #1, thereby updating it to “1” (at the 1st row and the 1st column in FIG. 10(c)). Controller 28-1 makes grants output to output scheduler 22-1 valid, i.e., sets them to “1” (at the 1st row and the 1st column in FIG. 10(d)), and makes grants output to output schedulers 22-2, 22-3, 22-4 invalid, i.e., sets them to “0” (at the 1st row and the 2nd column, the 1st row and the 3rd column, and the 1st row and the 4th column in FIG. 10(d)). Controller 27-2 of Input scheduler 21-2 searches for output lines for which the number of requests counted by the request counters is 1 or more, from output line #2 indicated by grant pointer g2 (24-2). Since the request counter from output line #2 has a count of 2, controller 27-2 selects output line #2 as a candidate that can be connected to input line #2. Controller 27-2 updates the value of the grant pointer to a value indicative of output line #3 according to the round-robin rules, and decrements by 1 the value of request counter 23-1-2 to selected output line #2, thereby updating it to “1” (at the 2nd row and the 2nd column in FIG. 10(c)). Controller 27-2 makes grants output to output scheduler 22-2 valid, i.e., sets them to “1” (at the 2nd row and the 2nd column in FIG. 10(d)), and makes grants output to output schedulers 22-1, 22-3, 22-4 invalid, i.e., sets them to “0” (at the 2nd row and the 1st column, the 2nd row and the 3rd column, and the 2nd row and the 4th column in FIG. 10(d)). Controller 27-3 of input scheduler 21-3 searches for output lines for which the number of request counted by the request counters is 1 or more, from output line #3 indicated by grant pointer g3 (24-3). Since the request counter from output line #3 has a count of 2, input scheduler 21-3 selects output line #3 as a candidate that can be connected to input line #3. Controller 27-3 updates the value of the grant pointer to output line #4 according to the round-robin rules, and decrements by 1 the value of request counter 23-1-3 to selected output line #3, thereby updating it to “1” (at the 2nd row and the 2nd column in FIG. 10(c)). Controller 27-3 makes grants output to output scheduler 22-3 valid, i.e., sets them to “1” (at the 3rd row and the 3rd column in FIG. 10(d)), and makes grants output to output schedulers 22-1, 22-2, 22-4 invalid, i.e., sets them to “0” (at the 3rd row and the 1st column, the 3rd row and the 2nd column, and the 3rd row and the 4th column in FIG. 10(d)). Controller 27-4 of input scheduler 21-4 searches for output lines for which the value of requests counted by the request counters is 1 or more, from output line #4 indicated by grant pointer g4 (24-4). Since the request counter from output line #4 has a count of 0, output line #4 cannot be selected as a candidate to which packets can be output. Since the number of requests counted by the request counter from output line #1, as it is referred to, according to the round-robin rules is 0, output line #1 cannot be selected as a candidate to which packets can be output. Since the number of requests counted by the request counter from output line #2, as it is referred to, is 1, controller 27-4 thus selects output line #2 as a candidate that can be connected to input line #4. Controller 27-4 updates the value of the grant pointer to a value indicative of output line #3 according to the round-robin rules, and decrements by 1 the value of request counter 23-4-2 to selected output line #2, thereby updating it to “0” (at the 4th row and the 2nd column in FIG. 10(c)). Controller 27-4 makes grants output to output scheduler 22-2 valid, i.e., sets them to “1” (at the 4th row and the 2nd column in FIG. 10(c)), and makes grants output to output schedulers 22-1, 22-3, 22-4 invalid, i.e., sets them to “0” (at the 4th row and the 1st column, the 4th row and the 3rd column, and the 4th row and the 4th column in FIG. 10(c)).

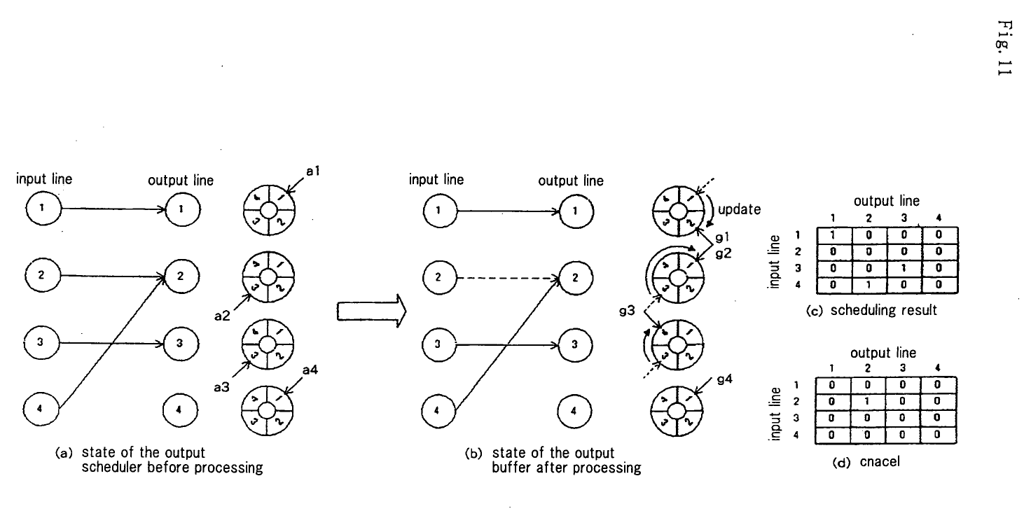

In step 3, output schedulers 22-1 through 22-4 select a grant for each input line from valid grants input from input schedulers 21-1 through 21-4 according to the round-robin rules (FIGS. 11(a) through 11(d)). FIG. 11(a) shows valid grants from the input lines to the output lines and accept pointers before step 3 is carried out, and FIG. 11(b) shows selected grants and accept pointers after step 3 is carried out. FIG. 11(c) shows scheduling results after step 3 is carried out, and FIG. 11(d) shows canceling information output from output schedulers 22-1 through 22-4 after step 3 is-carried out. Controller 28-1 of output scheduler 22-1 receives grants input from respective input schedulers 21-1 through 21-4 by grant registers 25-1-1 through 25-1-4. Controller 28-1 refers to grant register 25-1-2 for input line #1 indicated by accept pointer a1 (16-1), and it is valid, i.e., it is set to “1”. Therefore, controller 28-1 selects input line #1 as a line that can be connected to output line #1. Controller 28-1 updates the value of accept pointer a1 to input line #2 according to the round-robin rules. Controller 28-1 makes a scheduling result for output line #1 of input buffer 1-1 valid, i.e., sets it to “1”, (at the 1st row and 1st column in FIG. 11(c)), and makes scheduling results for output line #1 of input buffers 1-2, 1-3, 1-4 invalid, i.e., sets them to “0” (at the 1st row and the 2nd column, the 1st row and the 3rd column, and the 1st row and the 4th column in FIG. 11(c)). Controller 28-2 of output scheduler 22-2 receives grants input from respective input schedulers 21-1 through 21-4 using grant registers 25-2-1 through 25-2-4. Controller 28-2 refers to grant register 25-2-3 for input line #3 indicated by accept pointer a2 (16-2), and it is invalid, i.e., it is set to “0”. Therefore, controller 28-2 cannot select input line #3. Controller 28-2 refers to grant register 25-2-4 for input line #3 according to the round robin rules, and it is valid, i.e., it is set to “1”. Controller 28-2 selects input line #4 as a line that can be connected to output line #2. Controller 28-2 updates the value of accept pointer a2 to a value of Input line #1 according to the round-robin rules. Controller 28-2 makes a scheduling result for output line #2 of input buffer 14 valid, i.e., sets it to “1”, (at the 4th row and 2nd column in FIG. 11(c)), and makes scheduling results for output line #2 of input buffers 1-1, 1-2, 1-3 invalid, i.e., sets them to “0” (at the 1st row and the 2nd column, the 2nd row and the 2nd column, and the 3rd row and the 2nd column in FIG. 11(c)). Furthermore, controller 28-2 outputs information indicating that the grant for input line #2 that is not selected though the grant register is valid, has been canceled to input scheduler 21-2 (at the 2nd row and 2nd column in FIG. 11(c)). Output scheduler 22-3 receives grants input from respective input schedulers 21-1 through 21-4 by grant registers 25-3-1 through 25-3-4. Controller 28-3 of output scheduler 22-3 refers to grant register 25-3-3 for input line #3 indicated by accept pointer a3 (16-3), and it is valid, i.e., it is set to “1”. Therefore, controller 28-3 selects input line #3 as a line that can be connected to output line #3. Controller 28-3 updates the value of accept pointer a3 to a value indicative of input line #4 according to the round-robin rules. Controller 28-3 makes a scheduling result for output line #3 of input buffer 1-3 valid, i.e., sets it to “1”, (at the 3rd row and 3rd column in FIG. 11(c)), and makes scheduling results for output line #3 of input buffers 1-1, 1-2, 1-4 invalid, i.e., sets them to “0” (at the 1st row and the 3rd column, the 2nd row and the 3rd column, and the 4th row and the 3rd column in FIG. 11(c)). Controller 284 of output scheduler 22-4 receives grants input from respective input schedulers 21-1 through 21-4 by grant registers 25-4-1 through 25-4-4. Controller 284 refers to grant register 25-4-1 for input line #1 indicated by accept pointer a4 (26-4), and it is invalid, i.e., it is set to “0”. Therefore, controller 28-4 successively refers to grant registers 25-3-2, 25-3-3, 25-3-4 for input lines #2, #3, #4 according to the round robin rules, and all of them are invalid, i.e., they are set to “0”. Therefore, controller 28-4 judges that there is no line outputting packets to output line #4, and controls accept pointer a4 to hold the preceding value. Controller 28-4 makes scheduling results for output line #4 of input buffers 1-1, 1-2, 1-3, 1-4 invalid, i.e., sets them to “0” (at the 1st rod and 4th column, the 2nd row and the 4th column, and the 3rd row and the 4th column in FIG. 11(c)). The scheduling results are also used as connection settings of crossbar switch 2.

According to the second embodiment, the scheduling process is first performed on the input lines, and if a plurality of output lines are overlappingly selected according to the scheduling results, then one of the selected output lines is selected. Therefore, the second embodiment offers the same advantages as the first embodiment.

While preferred embodiments of the present invention have been described using specific terms, such description is for illustrative purposes only, and it is to be understood that changes and variations may be made without departing from the spirit or scope of the following claims.

What is claimed is:

1. A packet switch scheduling apparatus comprising:
a plurality of output schedulers each associated with each one of a plurality of output lines, said output schedulers each comprising request counters each associated with each one of a plurality of input lines for counting scheduling requests for connection settings of a crossbar switch which are required by an input buffer connected to the associated input line, a grant pointer for indicating an input line to which top priority is given according to the round robin rules, and output scheduler control means for referring to said request counters to select the input line to which top priority is given according to the round robin rules and which is indicated by said grant pointer, from input lines for which there are scheduling requests for the associated output line and
a plurality of input schedulers each associated with each one of said input lines, said input schedulers each comprising grant registers each associated with one of said output schedulers for holding the input line selected by the associated output scheduler as grant for the associated output line, an accept pointer for indicating an output line to which top priority is given according to the round robin rules, and an input scheduler control means for referring to said grant registers to select the output line to which top priority is given according to the round robin rules and which is indicated by said accept pointer, from output lines for the associated input line which are held as grants;
wherein, when said each input scheduler control means selects the output line, said each input scheduler control means outputs canceling information to the output scheduler which corresponds to the output line for the associated input line which is held as grant but not selected.

2. The packet switch scheduling apparatus according to claim 1, wherein when said each output scheduler control means is supplied with said canceling information from said each input scheduler control means, said each output scheduler control means judges said canceling information as a scheduling request similar to a new scheduling request input from said input buffer, updates the value of the request counter corresponding to the input line which corresponds to said input scheduler control means which has output said canceling information, and decrements the request counter which corresponds to said selected input line.

3. The packet switch scheduling apparatus according to claim 1, wherein when said each output scheduler control means selects the input line, said each output scheduler control means updates said grant pointer so as to indicate an input line next to the selected input line.

4. The packet switch scheduling apparatus according to claim 1, wherein said request counters count scheduling requests and said output scheduler control means selects an input line in each of said output schedulers, and said input scheduler control means select an output line in each of said input schedulers, independently of each other.

5. A packet switch scheduling apparatus comprising:
a plurality of input schedulers each associated each one of a plurality of input lines, said input schedulers each comprising request counters each associated with each one of a plurality of output lines for counting scheduling requests for connection settings of a crossbar switch which are required by a plurality of input buffers connected to the associated input line, a grant pointers for selecting one of the output lines to which is representative of a top priority line according to the round robin rules, and an input scheduler control means for referring to said request counters to select an output line to which top priority is given according to the round robin rules and which is indicated by said grant pointer, from output lines for which there are scheduling requests from the associated input line; and
a plurality of output schedulers each associated with each one of said output lines, said output schedulers each comprising grant registers each associated with one of said input schedulers for holding output lines selected by said input schedulers as grants for the associated input line, an accept pointer for selecting one of the input lines which is representative of a top priority line according to the round robin rules, and an output scheduler control means for referring to said grant registers to select an input line to which top priority is given according to the round robin rules and which is indicated by said accept pointer, from input lines for the associated output line which are held as grants;
wherein said each output scheduler control means outputs canceling information to said input schedulers which correspond to those input lines for the associated output line which are held as grants but not selected, when said output scheduler control means select an input line.

6. The packet switch scheduling apparatus according to claim 5, wherein when said each input scheduler control means is supplied with said canceling information from said each output scheduler control means, said each input scheduler control means judges said canceling information as a scheduling request similar to a new scheduling request input from said input buffers, update the value of the request counter corresponding to the input lines which corresponds to said output scheduler control means which has output said canceling information, and decrement the request counter which corresponds to the selected output line.

7. The packet switch scheduling apparatus according to claim 5, wherein when said each input scheduler control means select the output line, said each input scheduler control means updates said grant pointer so as to indicate an output line next to the selected output line.

8. The packet switch scheduling apparatus according to claim 5, wherein said request counters count scheduling requests and said input scheduler control means selects an output line in each of said input schedulers, and said output scheduler control means select an input line in each of said output schedulers, independently of each other.
